(19) United States
(12) Patent Application Publication
(10) Pub. No.: US 2007/0013212 A1
(43) Pub. Date: Jan. 18, 2007

(54) Bench seat for a vehicle

(76) Inventor: Helmut Meister, Neuburg (DE)

Correspondence Address: SHLESINGER, ARKWRIGHT & GARVEY LLP, 1420 KING STREET, SUITE 600, ALEXANDRIA, VA, 22314, US

(21) Appl. No.: 11/481,800

(22) Filed: Jul. 7, 2006

(30) Foreign Application Priority Data
Jul. 13, 2005 (DE) 10 2005 032 602.1

(51) Int. Cl. B60N 2/46

(52) U.S. Cl. 297/115; 297/113; 297/237

(57) ABSTRACT

Bench seat for a vehicle includes two side seats and one center seat. The side seats are equipped with permanent side padding components on their outer sides. The bench seat comfort of the side seats is increased as desired using simple expedients, such as the provision of complementary side walls for the inner sides of the backrests and/or the seat sections of the side seats, and which complementary side walls can be extended into the center seat, as well as out of and away from the center seat.

### CROSS-REFERENCE TO RELATED APPLICATIONS

This application claims the priority of German application no. 10 2005 032 602.1, filed Jul. 13, 2005, and which is incorporated herein by reference.

### FIELD OF THE INVENTION

The present invention relates to a bench seat for a vehicle, with two side seats and one center seat. More particularly, the invention relates to a bench seat for a vehicle, with two side seats and one center seat, and the side seats including permanent side padding components on their outer sides.

### BACKGROUND OF THE INVENTION

Vehicle bench seats having structural fittings that increase the variability of use or the comfort of the seats are known. For instance, in DE 200 00 479 U1 a row of seating for a vehicle is described, which is comprised of two full-sized side seats and one spare center seat. The latter can be completely stowed by folding the backrest forward onto the seat section, with the seat section of the spare seat then being positioned below the seat sections of the two side seats, while in this stowed position the backrest lies between the seat sections of the side seats. Each of the side seats is equipped with an armrest on its side that is adjacent to the spare seat; when folded up, these armrests complement the narrow backrest of the spare seat. When this narrow backrest is folded forward in its stowed position, space is opened up at the sides of the seat sections of the side seats, corresponding to the width of the armrests of the side seats. The side seats can be shifted in a transverse direction in this open space until they overlap the lowered seat section of the spare seat in this area. With this solution, the seating comfort of the side seats is increased by expanding the lateral space available for the arms toward both the body of the vehicle and the vehicle's interior. In this seating arrangement the backrests and the seat sections of the side seats are equipped on their outer and inner sides with raised side padding. The side padding on the inner sides is possible because the center seat is designed as a spare seat. This padding naturally impairs the already poor seating comfort of the spare seat.

In FR 2 812 594 B1 a vehicle seat is described in which side headrests can be folded upward from the side rolls on both sides of the backrest, around a horizontal pivoting axis located in the area of the headrest, wherein a passenger can rest his/her head against the headrests toward the side. Neck rolls are attached to the headrests toward the centers of the backrests, wherein the neck rolls are designed to form a single component with the side headrests, and are pivoted outward from the backrest surface when the side headrests are pivoted upward.

### OBJECTS AND SUMMARY OF THE INVENTION

The object of the present invention is to provide a bench seat of the described type in which the comfort of the side seats can be increased as desired via simple means.

This object is attained according to the invention with a bench seat for a vehicle including two side seats and one center seat. Each of the side seats and center seat include a backrest and a seat section. A permanent side padding component is provided on outer sides of each of the two side seats. a side wall is provided that is extendable into the center seat, and the side wall is complementary to the permanent side padding component on one of the two side seats, and the side wall is provided on an inner side of one of the backrest of one of the side seats and/or the seat section of one of the side seats. The side wall is extendable out of and away from the center seat.

Bench seats for vehicles are customarily designed such that side padding is provided at the outer sides of the two side seats, for the lateral support of passengers, while the area between the seats remains free of side padding, in order to avoid impairing seating comfort when the bench seat is fully occupied. Frequently, however, bench seats are occupied by only two persons sitting in the two side seats, for whom then lateral support is lacking on the inner side. This is where the present invention applies, in that it provides for complementary side walls for the inner sides of the seat sections and/or backrests of the side seats to be extended from the center seat. In this manner the side seats are turned into full seats, providing lateral support on both sides of a passenger.

In one advantageous embodiment of the invention, the side walls for the seat sections and the backrests of the side seats can be pivoted into their usable position, individually or in groups, kinematically coupled to one another. For example, a group formation(s) in which all side wall components, i.e. both the side walls for the backrests and the side walls for the seat sections of both side seats, are coupled to one another, so that they are pivoted into their usable position together, is sensible. If only one of the side seats is occupied, it may also make sense to pivot only the inner side walls that are allocated to this side seat into their usable position. These would then be uncoupled from the inner side walls of the other side seat and could also be pivoted together or individually into their usable position.

Advantageous further improvements on the invention are disclosed in the embodiments described herein.

Below, the invention will be described in greater detail with reference to various embodiments.

Relative terms such as up, down, left, and right are for convenience only and are not intended to be limiting.

It will be appreciated that the inner side walls may be understood to include inner side cushions or padding.

### BRIEF DESCRIPTION OF THE DRAWINGS

FIGS. 1-3 are perspective views from a frontal angle of a bench seat for a vehicle in various stages of conversion, according to a first embodiment of the invention;

FIGS. 4-6 are corresponding side views of the illustrations of FIGS. 1 through 3;

FIGS. 7-9 are perspective views from a frontal angle of a bench seat for a vehicle in various stages of conversion, according to a second embodiment of the invention;

FIGS. 10-12 are corresponding side views of the illustrations of FIGS. 7-9;

FIGS. 13-15 are perspective views from a frontal angle of a bench seat for a vehicle in various stages of conversion, according to a third embodiment of the invention;

FIG. 16 is a single illustration of a bridge section according to the embodiment shown in FIGS. 13-15, with an armrest in its stowed position; and

FIG. 17 is an illustration according to FIG. 16 with the armrest in its usable position.

### DETAILED DESCRIPTION OF THE INVENTION

All three embodiments relate to a bench seat 1 for a vehicle, which includes two side seats 2 and 3, respectively, and one center seat 4. Each of the seats 2 through 4 has a backrest 2.1, 3.1 or 4.1 and a seat section 2.2, 3.2 or 4.2, respectively. The seats 2 through 4 are attached to a vehicle base that is not shown here. The respective backrests 2.1, 3.1 and 4.1 are bordered toward the rear by a storage area or trunk space. They can be partitioned in the customary manner, and can be folded forward, individually or together as a unit, onto their respective seat sections 2.2, 3.2 and 4.2, creating a long-cargo channel with the storage area or trunk space. Each of the backrests 2.1, 3.1 and 4.1 is equipped with a respective height-adjustable headrest 2.3, 3.3 or 4.3, respectively.

The backrests 2.1 and 3.1 and the respective seat sections 2.2 and 3.2 of the side seats 2 and 3 are equipped with side padding components 2.4 and 2.5 or 3.4 and 3.5, respectively, for the purpose of laterally guiding passengers seated in those seats. Otherwise, the supporting surfaces of the backrests 2.1, 3.1 and 4.1 and the seating surfaces of the seat sections 2.2, 3.2 and 4.2 are without significant raised areas, especially side walls, in order to create relatively comfortable seating for three passengers in the seats 2, 3 and 4. If only two passengers are using the bench seat 1, the comfort of the side seats 2 and 3 can be increased. This will be described in greater detail further below with reference to the individual embodiments, wherein equivalent or functionally equivalent components in the respective embodiments are given the same reference numbers.

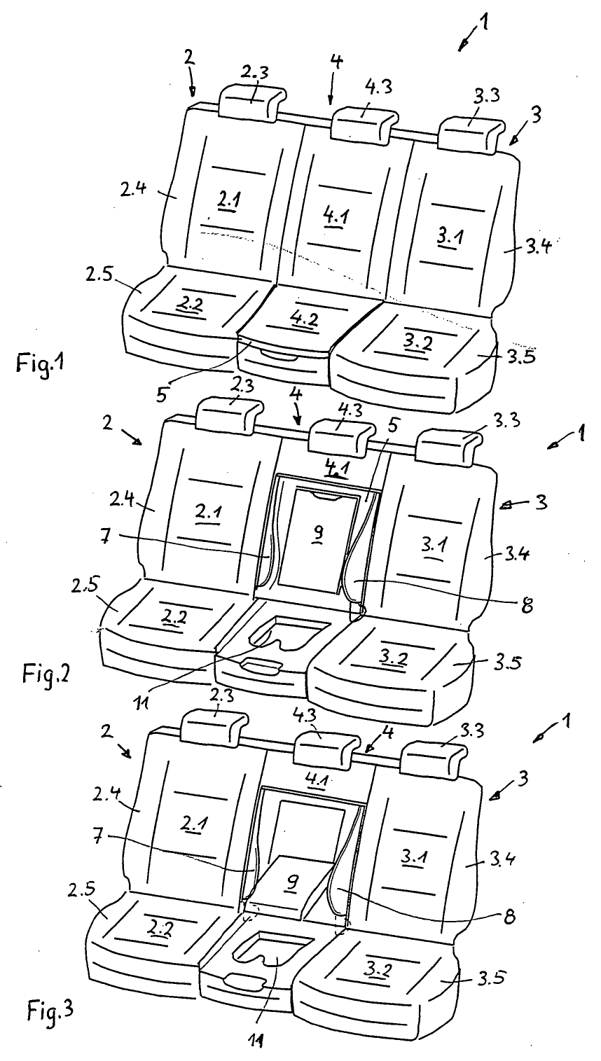

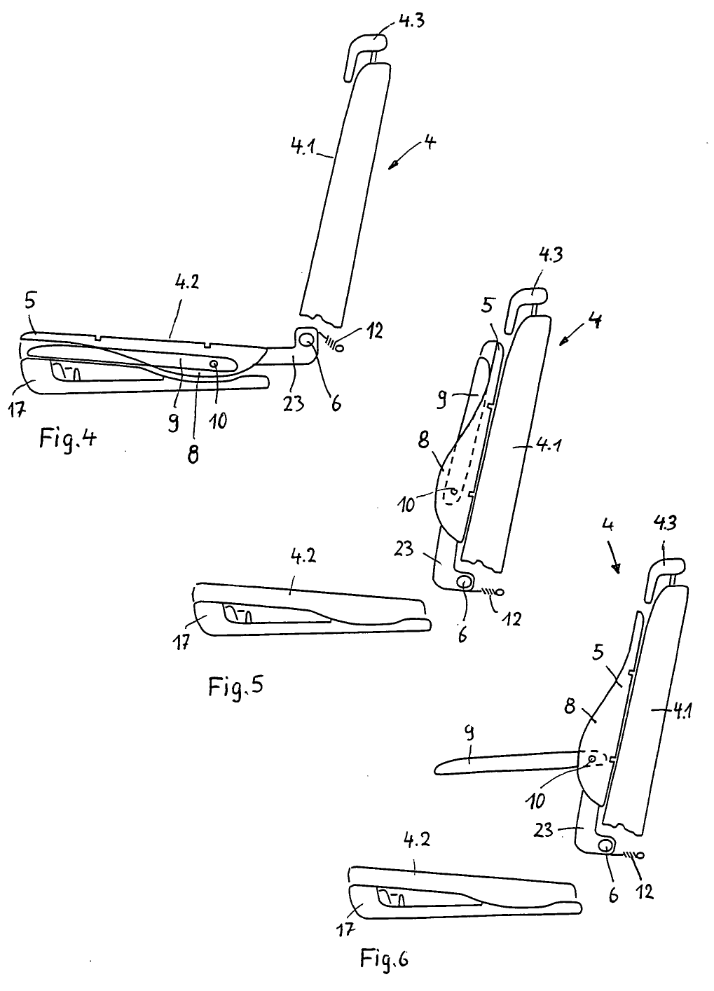

In the embodiment shown in FIGS. 1-6, the seating surface of the seat section 4.2 of the center seat 4 is formed by the back side of a bridge element 5, which can be pivoted out of the seat section 4.2, around a pivoting axis 6 formed on the seat section support structure 23 (FIGS. 4-6), upward and toward the rear against the backrest 4.1 of the center seat 4. This positioning is depicted in FIGS. 2 and 5. As is also apparent from these illustrations, on the underside of the bridge element 5 side walls 7 and 8 are formed as a single piece with the bridge element, wherein the side wall 7 is allocated to the side seat 2 and the side wall 8 is allocated to the side seat 3. When the bridge element 5 is resting on the seat section 4.2, the side walls 7 and 8 enter into the seat section such that they are not evident from the outside, and especially such that they do not compromise the seating comfort of the center seat 4.

An armrest 9 is integrated with bridge element 5, which armrest 9 can be folded forward from its non-use or stowed position, which is depicted in FIGS. 2 and 5, into its usable position, which is depicted in FIGS. 3 and 6, around a folding axis 10 that is formed on the support structure 23 of the bridge element 5 (FIGS. 4-6).

When the bridge element 5 is folded upward, a storage compartment 11 in which items may be stowed is opened up in the seat section 4.2 of the center seat 4. Of course, in place of the storage compartment 11 multimedia devices or drink or container holders may also be provided.

The comfort of the side seats 2 and 3 is substantially improved by the addition of the complementary side walls 7 and/or 8, the armrest 9, and the storage compartment 11. Naturally in simpler versions of this embodiment, for cost-saving purposes, the armrests 9 and the storage compartment 11 can be omitted.

The bridge element 5 is secured in place in both its stowed position (FIGS. 1 and 4) and its usable position (FIGS. 2, 3, 5, 6) by means of a corresponding latching mechanism 12, which is represented only schematically in FIGS. 4-6.

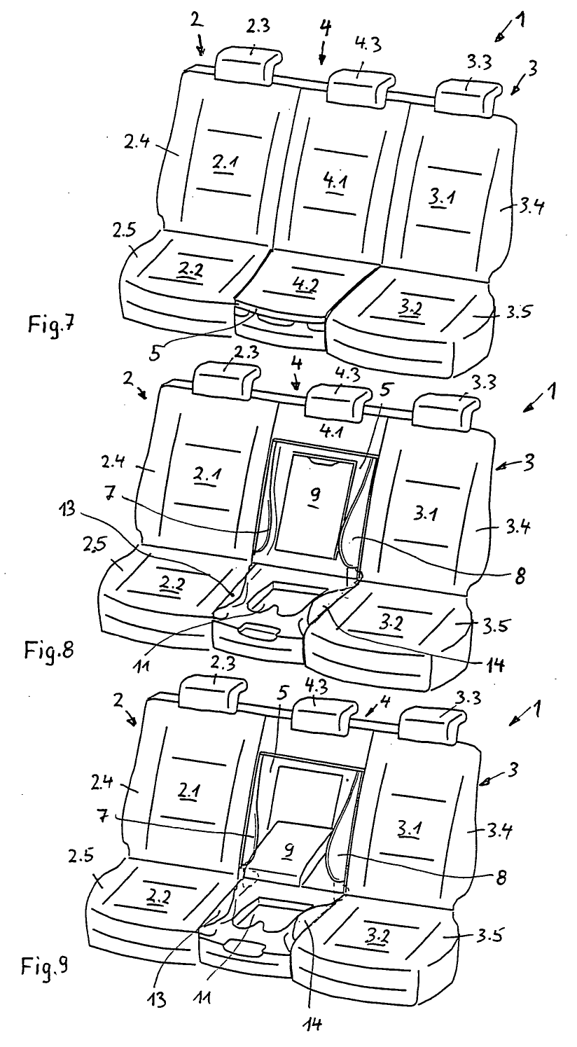

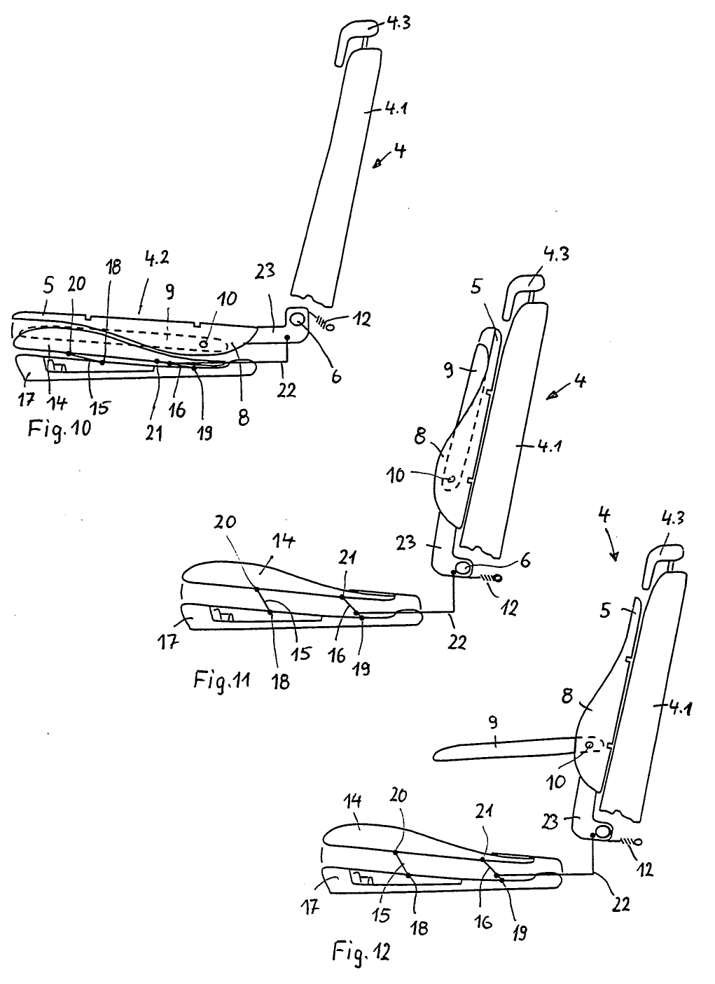

The embodiment shown in FIGS. 7-12 differs from the embodiment described above in that, in addition to the complementary side walls 7 and 8 for the backrests 2.1 and 3.1, respectively, complementary side walls 13 and 14 for the seat sections 2.2 and 3.2 of the side seats 2 and 3, respectively, are also provided. In this manner the seating comfort of the side seats 2 and 3 is improved even further over the preceding embodiment.

Each of the side walls 13 and 14 is connected to a base component 17 of the seat section 4.2 of the center seat 4 by means of a front link 15 and a rear link 16. The links 15, 16 are pivotally attached to the base component 17 via lower rotational points 18 and 19, respectively, and are pivotally attached to the side walls 13 and 14 via upper rotational points 20, 21, respectively. Each of the four-link joints 18 through 21 formed in this manner is connected via a coupling,rod 22 to the support structure 23 of the bridge element 5 that can pivot around the pivoting axis 6. When the bridge element 5 is pivoted from its stowed position to its usable position, tension is exerted on the four-link joints 18 through 21 via the coupling rods 22, so that the links 15, 16 pivot in a clockwise direction, as shown in the illustration, causing the side walls 13, 14 to be raised from the seat section 4.2 of the center seat 4. This process, or this kinematic, is illustrated in FIGS. 10 and 11.

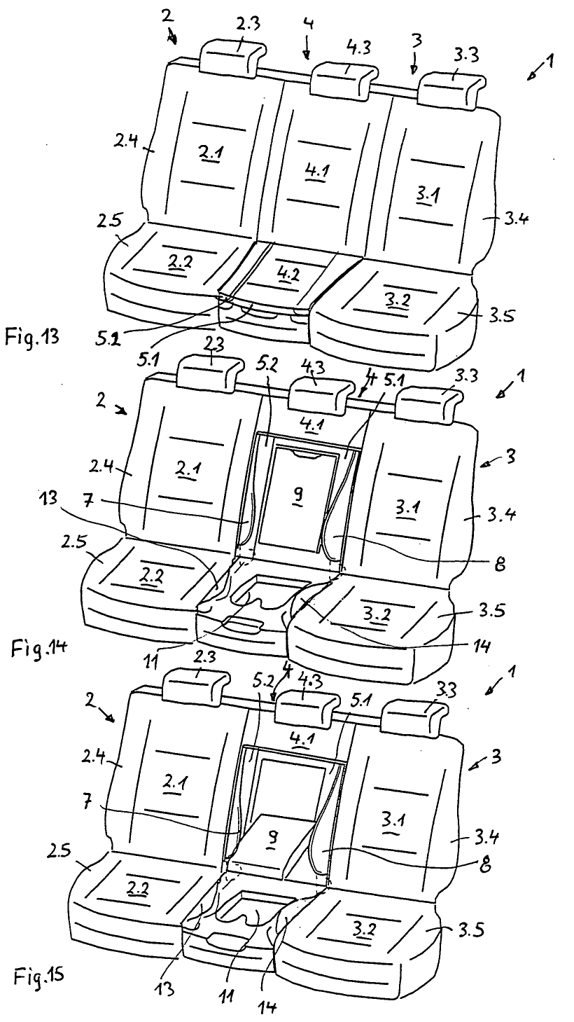

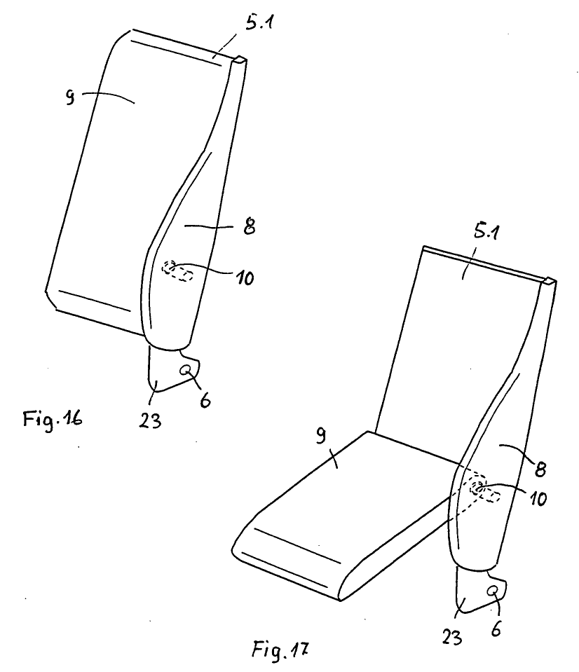

In the embodiment illustrated in FIGS. 13-17, the bridge element 5 is comprised of a wider partial bridge element 5.1 and a narrower partial bridge element 5.2, which are separate from one another and which together, with their combined widths, form a bridge element 5 that is equivalent to that of the preceding embodiments. The partial bridge element 5.1 is shown in FIGS. 16 and 17. As is depicted in these drawings, the side wall 8 is integrated into the partial bridge element 5.1 (correspondingly, the side wall 7 is integrated into the partial bridge element 5.2). Furthermore, an armrest 9 can be folded down from the partial bridge element 5.1, as is shown in FIGS. 15 and 17. To this end a folding axis 10 is provided in the support structure 23 of the partial bridge element 5.1. The partial bridge element 5.1 can be pivoted separately from the partial bridge element 5.2 from its stowed position (FIG. 13) to its usable position (FIGS. 14-17) around a pivoting axis 6. As a result of the partitioning of the bridge element 5 into two separate partial bridge elements 5.1 and 5.2, the side walls 7 and 8 are uncoupled, i.e. they can be pivoted as needed, separately from one another, into their usable positions.

By uncoupling the side walls 7 and 8 for the backrests 2.1 and 3.1 of the side seats 2 and 3, respectively, the side walls 13 and 14 for the seat sections 2.2 and 3.2 of the side seats 2 and 3, respectively, are also uncoupled. Their four-link joints 18 through 21 are also connected via coupling rods 22 to the support structures 23 (see FIGS. 10-12) of the partial bridge elements 5.1 or 5.2, in other words, when the partial bridge element 5.1 is pivoted upward, the side wall 14 is simultaneously pivoted into its usable position, and when the partial bridge element 5.2 is pivoted upward, the side wall 13 is simultaneously pivoted into its usable position.

Of course, in the embodiments shown in FIGS. 7-12 and in FIGS. 13-17, the armrests 9 and/or the storage compartment 11 can also be omitted for cost-saving purposes.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Bench seat for a vehicle, comprising:
a) two side seats and one center seat, each of the side seats and center seat having a backrest and a seat section;
b) a permanent side padding component provided on outer sides of each of the two side seats;
c) a side wall extendable into the center seat, the side wall being complementary to the permanent side padding component on one of the two side seats, and being provided on an inner side of one of:
i) the backrest of one of the side seats; and
ii) the seat section of one of the side seats; and
d) the side wall being extendable out of and away from the center seat.

2. Bench seat according to claim 1, wherein:
a) the side wall extendable into the center seat is a complementary side wall for the backrest of one of the side seats, and the side wall is pivotable from a non-disruptive stowed position in the seat section center seat out of the seat section center seat into a use position when the side wall is extended out of and away from the center seat; and
b) the side wall includes one of:
i) an individual side wall which includes a seat surface of the seat section of the center seat, the individual side wall being coupled to a bridge element, and in the use position the bridge element rests against the backrest of the center seat; and
ii) two side walls which include a seat surface of the seat section of the center seat, two side walls being coupled to one another by a bridge element defining the seat surface of the center seat, and in the use position the bridge element rests against the backrest of the center seat.

3. Bench seat according to claim 2, wherein:
a) the side wall extendable into the center seat is a complementary side wall for the seat section of one of the side seats, and the side wall is pivotable from a non-disruptive stowed position in the seat section center seat out of the seat section center seat into a use position.

4. Bench seat according to claim 1, wherein:
a) the side wall extendable into the center seat includes two side walls which include a seat surface of the seat section of the center seat; and
b) the two side walls are kinematically coupled to one another such that they can be moved together to their usable positions.

5. Bench seat according to claim 4, wherein:
a) the two side walls are pivotable via a front link and a rear link.

6. Bench seat according to claim 5, wherein:
a) the links are attached to a bridge element via a coupling rod.

7. Bench seat according to claim 3, wherein:
a) an armrest is integrated into the bridge element, and is foldable from a stowed position to a usable position.

8. Bench seat according to claim 2, wherein:
a) the side wall is secured in place in both its usable position and its stowed position by a latching mechanism.

9. Bench seat according to claim 1, wherein:
a) the side wall extendable into the center seat is a complementary side wall for the seat section of one of the side seats, and the side wall is pivotable from a non-disruptive stowed position in the seat section center seat out of the seat section center seat into a use position.

10. Bench seat according to claim 1, wherein:
a) the side wall extendable into the center seat includes two side walls which include a seat surface of the seat section of the center seat; and
b) the two side walls are kinematically coupled to one another such that they can be moved together to their usable positions.

11. Bench seat according to claim 4, wherein:
a) an armrest is provided for each sidewall, integrated into the bridge element, and foldable from a stowed position to a usable position.
